(19) United States
(12) Patent Application Publication
(10) Pub. No.: US 2011/0298773 A1
(43) Pub. Date: Dec. 8, 2011

(54) DISPLAY DEVICE AND METHOD FOR DRIVING SAME

(75) Inventor: Norio Ohmura, Osaka-shi (JP)

(73) Assignee: Sharp Kabushiki Kaisha, Osaka-shi, OSAKA (JP)

(21) Appl. No.: 13/138,427

(22) PCT Filed: Oct. 27, 2009
(86) PCT No.: PCT/JP2009/068414

§ 371 Date: Aug. 12, 2011

(30) Foreign Application Priority Data
Feb. 18, 2009 (JP) 2009-035406

(51) Int. Cl. G09G 5/00

(52) U.S. Cl. 345/211

(57) ABSTRACT

An output stage of a common electrode driving circuit includes a plurality of sub-output stages each of which is capable of supplying a voltage to a common electrode, wherein each supply period of a common electrode potential of each polarity is divided into a plurality of partial periods, a voltage is supplied to the common electrode during each of the plurality of partial periods by one or more sub-output stages selected for said each of the plurality of partial periods, and overall load driving capability of an initial sub-output stage constituted by the one or more sub-output stages selected during a partial period including start of an operation of polarity inversion of the common electrode potential is smaller than overall load driving capability of a final sub-output stage constituted by one or more sub-output stages selected during a partial period in which a finally attained potential of the common electrode potential of each polarity is supplied.

### TECHNICAL FIELD

The present invention relates to a display device which carries out common inversion driving.

### BACKGROUND ART

Some liquid crystal display devices carry out common inversion driving. The common inversion driving is a driving mode for inverting an electric potential (positive or negative) of a common electrode in AC driving. For example, as shown in FIG. 10, in gate bus line inversion driving, a gradation reference voltage range Vp of positive polarity data is made equal to a gradation reference voltage range Vn of negative polarity data, and a common electrode potential Vcom is inverted every horizontal period between two levels, i.e., a voltage level V1 higher than the gradation reference voltage ranges and a voltage level V2 lower than the gradation reference voltage ranges. In a case where the positive polarity data is written into a picture element, the common electrode potential Vcom is set to the voltage level V2, whereas in a case where the negative polarity data is written into a picture element, the common electrode potential Vcom is set to the voltage level V1.

According to the common inversion driving, it is unnecessary to separately prepare the gradation reference voltage range of the positive polarity data and the gradation reference voltage range of the negative polarity data. Accordingly, it is possible to lower a power supply voltage. Further, since the gradation reference voltage is common between the positive polarity data and the negative polarity data, it is possible to simplify a configuration of a circuit for generating the gradation reference voltage.

In a case where the common inversion driving is carried out, a common electrode potential Vcom is supplied from an output stage 101 of a common electrode driving circuit to a common electrode 103, as shown in FIG. 9. The output stage 101 switches a voltage level every horizontal period between the voltage level V1 of a high potential side and the voltage level V2 of a low potential side in accordance with an inputted common polarity inversion signal that is switched between High and Low. Then, a voltage is outputted from a COM output terminal 102. The common electrode 103 is connected to the COM output terminal 102. The common electrode 103 and a picture element electrode 104, which are separated by a liquid crystal layer, constitute a liquid crystal capacitor CL. The common electrode 103 itself has a capacitor, too. Accordingly, the common inversion driving is an operation in which the common electrode driving circuit charges these capacitors alternately positively and negatively.

### Citation List

Patent Literature 1

Japanese Patent Application Publication, Tokukai, No. 2006-178072 A (Publication Date: Jul. 6, 2006)

Patent Literature 2

Japanese Patent Application Publication, Tokukaihei, No. 4-284489 A (Publication Date: Oct. 9, 1992)

### SUMMARY OF INVENTION

### Technical Problem

However, conventional common inversion driving causes a problem that a charge/discharge current Icom having a large peak is generated in a path through which an electric potential is supplied to the common electrode 103 when the common electrode potential Vcom is inverted, as shown in FIG. 10. This is because (i) the output stage 101 of the common electrode driving circuit which output stage 101 is constituted by push-pull output stages includes an output transistor Tp on a positive polarity side of the common electrode potential Vcom (p-channel field-effect transistor), and an output transistor Tn on a negative polarity side of the common electrode potential Vcom (n-channel field-effect transistor), (ii) ON resistances of the output transistor Tp and the output transistor Tn are small, and (iii) these ON resistances control an output impedance of the output stage 101, as shown in FIG. 11. Each of the output transistor Tp and the output transistor Tn may be a bipolar transistor. In a case where the common polarity inversion signal has a High level, the output transistor Tn is turned ON, whereas the common polarity inversion signal has a Low level, the output transistor Tp is turned ON. This inrush current causes a radiation noise.

Accordingly, in a case where a liquid crystal display device includes a liquid crystal panel 111 and a capacitive touch panel 112 which is provided above the liquid crystal panel 111 and is separated by a gap from the liquid crystal panel 111 as shown in FIG. 12, a detection operation of the touch panel 112 includes processing of integrating a signal for detecting a change in electrostatic capacitance. Accordingly, the detection operation of the touch panel 112 is easily affected by the radiation noise. Consequently, an error arising from the radiation noise is incurred in the detection result. This causes a reduction in detection accuracy of the touch panel 112, thereby causing a remarkable deterioration in sensitivity of the touch panel 112.

In the power supply circuit 100 disclosed in Patent Literature 1 (see FIG. 13), a VCOMH generating circuit 110 (high-potential-side voltage generating circuit) outputs a high-potential-side voltage VCOM on the basis of a high-potential-side input voltage, and a VCOML generating circuit 120 (low-potential-side voltage generating circuit) outputs a low-potential-side voltage VCOM on the basis of a low-potential-side input voltage. The power supply circuit 100 is capable of controlling common electrode potential supplying capability with the use of the VCOMH generating circuit 110 and the VCOML generating circuit 120. Specifically, the power supply circuit 100 increases the common electrode potential supplying capability in a case where the common electrode potential declines, and decreases the common electrode potential supplying capability in the other cases by polarity inversion of the common electrode potential or voltage application to a picture element electrode.

However, according to the power supply circuit 100 disclosed in Patent Literature 1, the common electrode potential supplying capability is increased in a case where a decline in the common electrode potential is large. Accordingly, a peak of an inrush current is large. Consequently, in a case where a touch panel is provided on a liquid crystal panel, a radiation noise caused by the inrush current has a large influence, and detection accuracy of the touch panel declines.

The display driving circuit of a plasma display panel disclosed in Patent Literature 2 (see FIG. 14) is arranged such that a Y-side driver circuit 12 and an X-side driver circuit 13 drive capacitive display cells 11 disposed in a matrix. In the display driving circuit, a Y-side timing generator 32 supplies a Y-side applied pulse YSUS to a transistor QY1 and supplies a Y-side tri-state control signal YTSC to a transistor QY2, and an X-side timing generator 33 supplies an X-side applied pulse XSUS to a transistor QX1 and supplies an X-side tri-state control signal XTSC to a transistor QX2. In a case where the tri-state control signal YTSC has an “L” level, an output of the Y-side driver circuit 12 is in a high impedance state, and in a case where the tri-state control signal XTSC has an “L” level, an output of the X-side driver circuit 13 is in a high impedance state.

In the display driving circuit of FIG. 14, when the Y-side applied pulse YSUS or the X-side applied pulse XSUS is applied, the tri-state control signal YTSC or XTSC is brought into an “L” level immediately before rising and falling of a corresponding pulse so that an output of the Y-side driver circuit 12 or the X-side driver circuit 13 is brought into a high impedance state, as shown in FIG. 15. Thus, an electric current level of a displacement current flowing through a capacitor of the display cell 11 is reduced. Further, during falling of the pulse, the pulse falls while an electric current is suppressed, and an X-side applied pulse XSUS of a high voltage or Y-side applied pulse YSUS of a high level is applied to a counter electrode driver circuit so that an output of the counter electrode driver circuit is brought into a low impedance state. This makes it possible to suppress a grand noise which occurs due to a radiation noise caused by switching or a discharge electric current during falling of an applied pulse of a high voltage.

The display driving circuit attempts to reduce the radiation noise and grand noise as above. However, such a noise suppressing method can be applied to a driving method of a plasma display panel, but cannot be applied to common inversion driving of a liquid crystal display device. Further, this method merely suppresses an electric current, and therefore there arises a problem such as an increased discharge time.

As described above, according to the conventional common inversion driving, it is impossible to effectively suppress a radiation noise generated when a common electrode potential is inverted.

The present invention was attained in view of the above problems, and an object of the present invention is to provide a display device which is capable of effectively suppressing a radiation noise generated when a common electrode potential is inverted and a method for driving the display device.

### Solution to Problem

In order to attain the above object, a display device of the present invention which carries out common inversion driving, includes a common electrode driving circuit including an output stage, the output stage including a plurality of sub-output stages each of which is capable of supplying a voltage to a common electrode, each supply period of a common electrode potential of each polarity being divided into a plurality of partial periods, and a voltage being supplied to the common electrode during each of the plurality of partial periods by one or more sub-output stages selected for said each of the plurality of partial periods, overall load driving capability of an initial sub-output stage constituted by one or more sub-output stages selected during a partial period including start of an operation of polarity inversion of the common electrode potential being smaller than overall load driving capability of a final sub-output stage constituted by one or more sub-output stages selected during a partial period in which a finally attained potential of the common electrode potential of each polarity is supplied.

According to the invention, only an electric current having a reduced peak flows, as an electric current flowing through a common electrode, at a start timing of each of the partial periods which include a partial period in which a voltage is outputted by the initial sub-output stage and which are included in a transition period in which a polarity of the common electrode potential is inverted.

Consequently, it is possible to suppress occurrence of a radiation noise caused by charge/discharge current of a common electrode at the time of common inversion, unlike the conventional techniques.

This produces an effect that it is possible to provide a display device that is capable of effectively suppressing a radiation noise which occurs at the time of inversion of a common electrode potential.

In order to attain the above object, a method of the present invention for driving a display device which carries out common inversion driving, the display device including a plurality of sub-output stages each of which is capable of outputting a voltage to a common electrode, includes the steps of: dividing each supply period of a common electrode potential of each polarity into a plurality of partial periods; and causing one or more sub-output stages included in an output stage of a common electrode driving circuit to supply a voltage to the common electrode during each of the plurality of partial periods, said one or more sub-output stages being selected for said each of the plurality of partial periods, overall load driving capability of an initial sub-output stage constituted by one or more sub-output stages selected during a partial period including start of an operation of polarity inversion of the common electrode potential being smaller than overall load driving capability of a final sub-output stage constituted by one or more sub-output stages selected during a partial period in which a finally attained potential of the common electrode potential of each polarity is supplied.

According to the invention, only an electric current having a reduced peak flows, as an electric current flowing through a common electrode, at a start timing of each of the partial periods which include a partial period in which a voltage is outputted by the initial sub-output stage and which are included in a transition period in which a polarity of the common electrode potential is inverted.

Consequently, it is possible to suppress occurrence of a radiation noise caused by charge/discharge current of a common electrode at the time of common inversion, unlike the conventional techniques.

This produces an effect that it is possible to provide a method for driving a display device that is capable of effectively suppressing a radiation noise which occurs at the time of inversion of a common electrode potential.

In order to attain the above object, a display device of the present invention which carries out common inversion driving is arranged such that during each supply period of a common electrode potential of each polarity, a waveform of the common electrode potential rises at a first change rate from when polarity inversion of the common electrode potential starts till when a halfway potential on an opposite polarity side to a polarity of a finally attained potential is reached, and the waveform of the common electrode potential rises at a second change rate larger than the first change rate until the finally attained potential is reached.

According to the invention, only an electric current having a reduced peak flows, as an electric current flowing through a common electrode, during a transition period in which a polarity of a common electrode potential is inverted.

Consequently, it is possible to suppress occurrence of a radiation noise caused by charge/discharge current of a common electrode at the time of common inversion, unlike the conventional techniques.

This produces an effect that it is possible to provide a display device that is capable of effectively suppressing a radiation noise which occurs at the time of inversion of a common electrode potential.

In order to attain the above object, a method of the present invention for driving a display device which carries out common inversion driving is arranged such that during each supply period of a common electrode potential of each polarity, a waveform of the common electrode potential rises at a first change rate from when polarity inversion of the common electrode potential starts till when a halfway potential on an opposite polarity side to a polarity of a finally attained potential is reached, and the waveform of the common electrode potential rises at a second change rate larger than the first change rate until the finally attained potential is reached.

According to the invention, only an electric current having a reduced peak flows, as an electric current flowing through a common electrode, during a transition period in which a polarity of a common electrode potential is inverted.

Consequently, it is possible to suppress occurrence of a radiation noise caused by charge/discharge current of a common electrode at the time of common inversion, unlike the conventional techniques.

This produces an effect that it is possible to provide a method for driving a display device that is capable of effectively suppressing a radiation noise which occurs at the time of inversion of a common electrode potential.

### Advantageous Effects of Invention

As described above, a display device of the present invention which carries out common inversion driving, includes a common electrode driving circuit including an output stage, the output stage including a plurality of sub-output stages each of which is capable of supplying a voltage to a common electrode, each supply period of a common electrode potential of each polarity being divided into a plurality of partial periods, and a voltage being supplied to the common electrode during each of the plurality of partial periods by one or more sub-output stages selected for said each of the plurality of partial periods, overall load driving capability of an initial sub-output stage constituted by one or more sub-output stages selected during a partial period including start of an operation of polarity inversion of the common electrode potential being smaller than overall load driving capability of a final sub-output stage constituted by one or more sub-output stages selected during a partial period in which a finally attained potential of the common electrode potential of each polarity is supplied.

This produces an effect that it is possible to provide a display device that is capable of effectively suppressing a radiation noise which occurs at the time of inversion of a common electrode potential.

As described above, a method of the present invention for driving a display device which carries out common inversion driving, the display device including a plurality of sub-output stages each of which is capable of outputting a voltage to a common electrode, includes the steps of: dividing each supply period of a common electrode potential of each polarity into a plurality of partial periods; and causing one or more sub-output stages included in an output stage of a common electrode driving circuit to supply a voltage to the common electrode during each of the plurality of partial periods, said one or more sub-output stages being selected for said each of the plurality of partial periods, overall load driving capability of an initial sub-output stage constituted by one or more sub-output stages selected during a partial period including start of an operation of polarity inversion of the common electrode potential being smaller than overall load driving capability of a final sub-output stage constituted by one or more sub-output stages selected during a partial period in which a finally attained potential of the common electrode potential of each polarity is supplied.

This produces an effect that it is possible to provide a method for driving a display device that is capable of effectively suppressing a radiation noise which occurs at the time of inversion of a common electrode potential.

### BRIEF DESCRIPTION OF DRAWINGS

FIG. 1 is a circuit block diagram illustrating a first arrangement of an output stage of a common electrode driving circuit in accordance with an embodiment of the present invention.

FIG. 2 is a waveform diagram showing an operation waveform of the output stage of FIG. 1.

FIG. 3 is a block diagram illustrating an arrangement of a display device in accordance with an embodiment of the present invention.

FIG. 4 is a circuit block diagram illustrating a second arrangement of the output stage of the common electrode driving circuit in accordance with the embodiment of the present invention.

FIG. 5 is a waveform diagram showing an operation waveform of the output stage of FIG. 4.

FIG. 6 is a circuit block diagram illustrating a third arrangement of the output stage of the common electrode driving circuit in accordance with the embodiment of the present invention.

FIG. 7 is a circuit block diagram illustrating a fourth arrangement of the output stage of the common electrode driving circuit in accordance with the embodiment of the present invention.

FIG. 8 is a waveform diagram showing an operation waveform of the output stage of FIG. 7.

FIG. 9 is a circuit block diagram illustrating an arrangement of an output stage of a conventional common electrode driving circuit.

FIG. 10 is a waveform diagram showing an operation waveform of the common electrode driving circuit of FIG. 9.

FIG. 11 is a circuit diagram illustrating a detailed arrangement of the output stage of the common electrode driving circuit of FIG. 9.

FIG. 12 is a cross-sectional view illustrating an arrangement of a conventional liquid crystal display device including a touch panel.

FIG. 13 is a circuit block diagram illustrating another exemplary arrangement of a conventional common electrode driving circuit.

FIG. 14 is a circuit block diagram illustrating an arrangement of a display driving circuit of a conventional plasma display panel.

FIG. 15 is a waveform diagram showing an operation waveform of the display driving circuit of FIG. 14.

### DESCRIPTION OF EMBODIMENTS

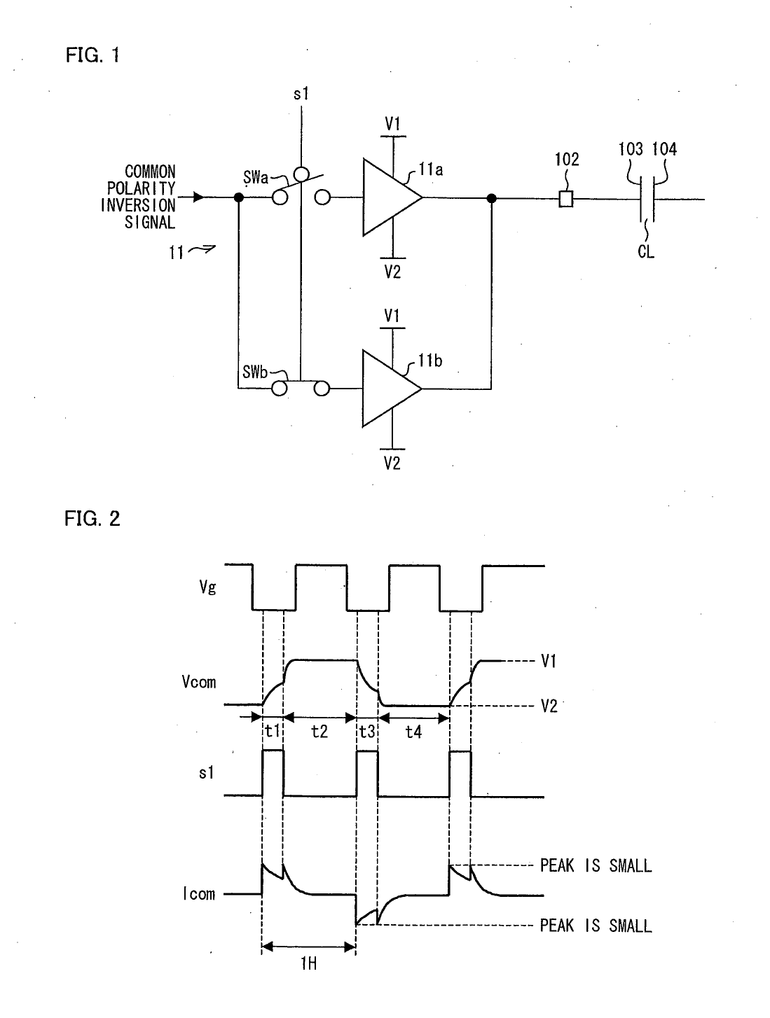

An embodiment of the present invention is described below with reference to FIGS. 1 through 8.

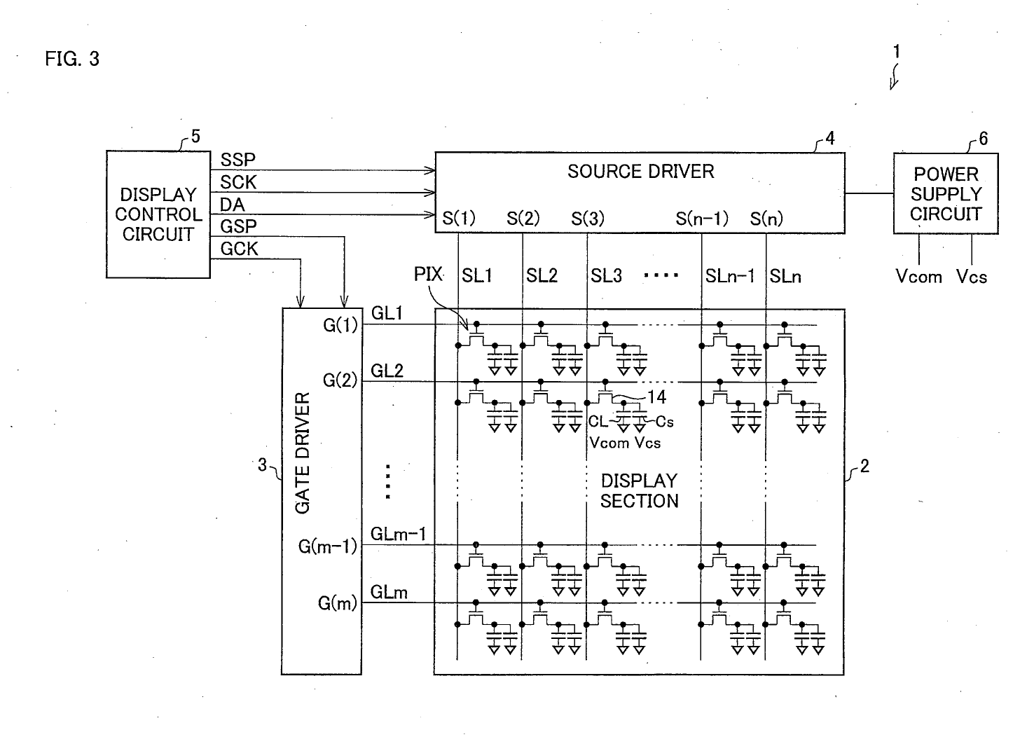

FIG. 3 shows an arrangement of a liquid crystal display device (display device) 1 of the present embodiment.

The liquid crystal display device 1 is an active matrix type display device, and includes a gate driver 3 serving as a scanning signal line driving circuit, a source driver 4 serving as a data signal line driving circuit, a display section 2, a display control circuit 5 for controlling the gate driver 3 and the source driver 4, and a power supply circuit 6. The liquid crystal display device 1 carries out, as AC driving, driving (e.g., gate line inversion driving or driving for inverting a polarity every plural lines) in which all the picture elements of each line has the same data polarity during the same horizontal period. Further, the liquid crystal display device 1 carries out common inversion driving in which a polarity of a common electrode potential is inverted between a period for supplying positive polarity data to a panel and a period for supplying negative polarity data to the panel.

The display section 2 includes a plurality of (m) gate lines GL1 to GLm serving as scanning signal lines, a plurality of (n) source lines SL1 to SLn serving as data signal lines each of which intersects with the plurality of gate lines GL1 to GLm, and a plurality of (m×n) picture elements PIX . . . provided corresponding to the intersections between the plurality of gate lines GL1 to GLm and the plurality of source lines SL1 to SLn. Further, the display section 2 includes retention capacitor wires CSL . . . (not shown) in a direction parallel to the plurality of gate lines GL1 to GLm. A single retention capacitor wire CSL is assigned to each picture element row constituted by n picture elements disposed in the direction.

The plurality of picture elements PIX . . . are disposed in a matrix so as to constitute a picture element array. Each of the plurality of picture elements PIX includes a TFT 14, a liquid crystal capacitor CL, and a retention capacitor Cs. A gate electrode of the TFT 14 is connected to a gate line GLj (1≦j≦m), a source electrode of the TFT 14 is connected to a source line SLi (1≦i≦n), and a drain electrode of the TFT 14 is connected to a picture element electrode. The liquid crystal capacitor CL is constituted by a picture element electrode, a common electrode facing the picture element electrode, and a liquid crystal layer sandwiched between the picture element electrode and the common electrode. To the common electrode, a common electrode potential Vcom is applied from the power supply circuit 6. To the retention capacitor wire CSL . . . , a retention capacitor potential Vcs is applied from the power supply circuit 6. The liquid crystal capacitor CL and the retention capacitor Cs constitute a picture element capacitor, but a parasitic capacitor formed between the picture element electrode and peripheral wiring also constitutes the picture element capacitor.

The display control circuit 5 supplies a gate start pulse GSP and a gate clock signal GCK to the gate driver 3, and supplies a source start pulse SSP, a source clock signal SCK, and display data DA to the source driver 4. The power supply circuit 6 generates a gradation reference voltage and supplies the gradation reference voltage to the source driver 4, and in addition generates and outputs the common electrode potential Vcom and the retention capacitor potential Vcs.

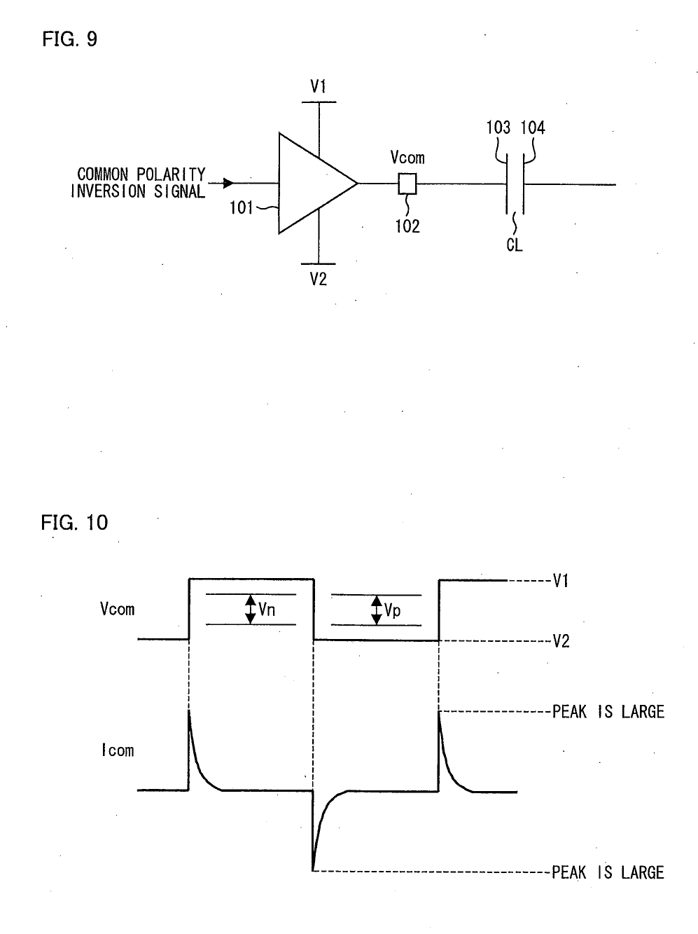

Next, an arrangement of a common electrode driving circuit included in the power supply circuit 6 shown in FIG. 3 is described below with reference to the Configurations. In the following Examples, a COM output terminal 102 and a liquid crystal capacitor CL constituted by a common electrode 103, a picture element electrode 104, and a liquid crystal layer sandwiched between the common electrode 103 and the picture element electrode 104 are connected to each other in a similar manner to FIG. 9.

[Configuration 1]

FIG. 1 shows an arrangement of an output stage 11 of a common electrode driving circuit of the present configuration.

The output stage 11 includes a first output stage (sub-output stage, final sub-output stage) 11a, a first switch SWa, a second output stage (sub-output stage, initial sub-output stage) 11b, and a second switch SWb.

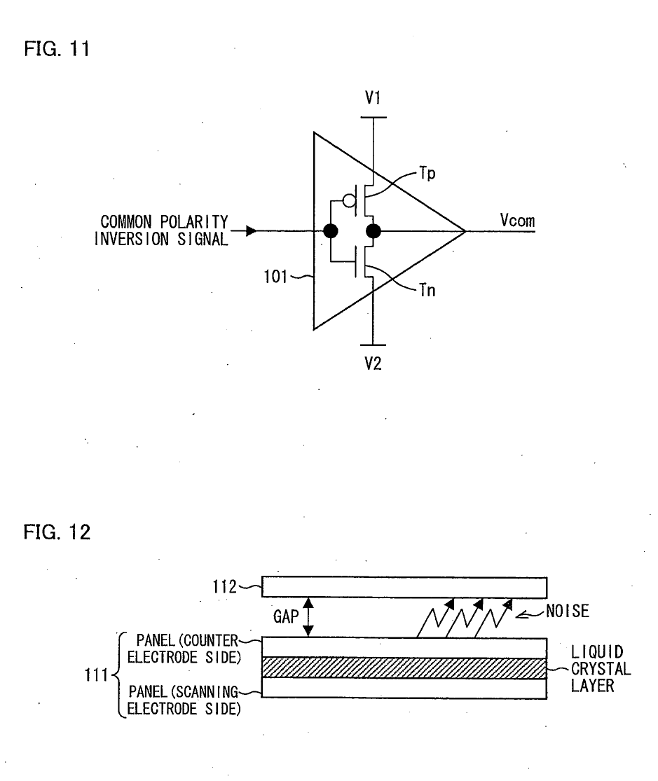

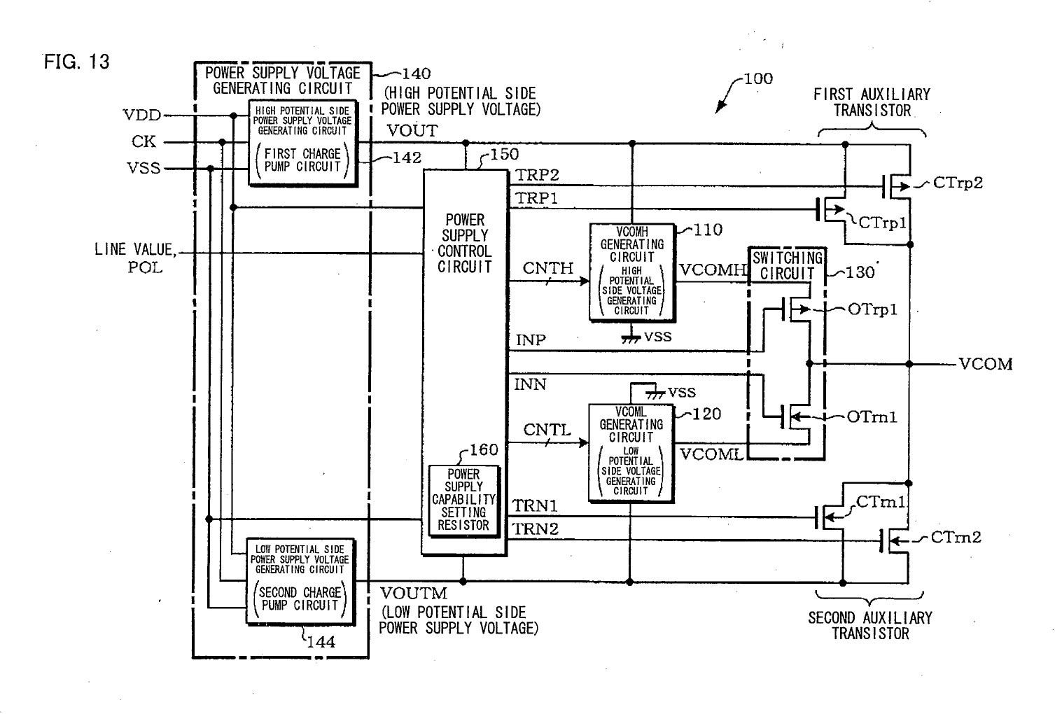

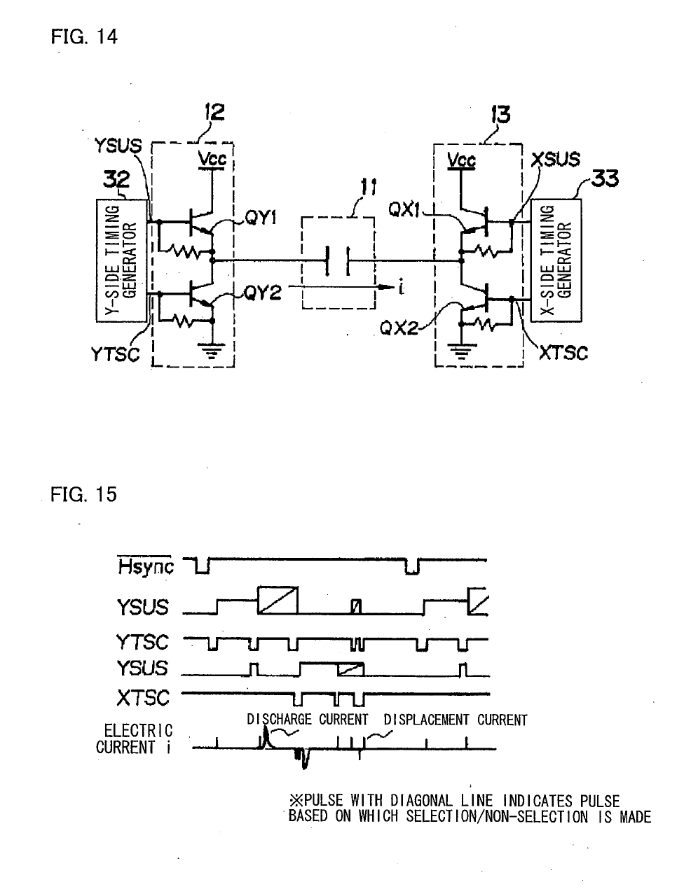

Both the first output stage 11a and the second output stage 11b are constituted by output transistors Tp and Tn, as in the case of FIG. 11.

The output transistor Tp of the second output stage 11b has a larger ON resistance than the output transistor Tp of the first output stage 11a, and the output transistor Tn of the second output stage 11b has a larger ON resistance than the output transistor Tn of the first output stage 11a. The ON resistance can be increased, for example, by reducing a channel width W of a transistor or by increasing a channel length L. Accordingly, an output impedance of the second output stage 11b is larger than that of the first output stage 11a. That is, the second output stage 11b has smaller load driving capability than the first output stage 11a.

An output of the first output stage 11a and an output of the second output stage 11b are both connected to the COM output terminal 102. Both the first output stage 11a and the second output stage 11b output a voltage level V1, which is a common electrode potential Vcom of a positive polarity, via the output transistor Tp, and outputs a voltage level V2 (V2<V1), which is a common electrode potential Vcom of a negative polarity, via the output transistor Tn.

The first switch SWa is connected in series with an input side of the first output stage 11a, and turns ON/OFF in accordance with a control signal s1 so that a common polarity inversion signal is allowed/not allowed to be supplied to the first output stage 11a. The second switch SWb is connected in series with an input side of the second output stage 11b, and turns ON/OFF in accordance with a control signal s1 so that a common polarity inversion signal is allowed/not allowed to be supplied to the second output stage 11b.

Both (i) a terminal of the first switch SWa which terminal is opposite to a terminal connected to the input side of the first output stage 11a and (ii) a terminal of the second switch SWb which terminal is opposite to a terminal connected to the input side of the second output stage 11b are connected to a supply source of the common polarity inversion signal.

FIG. 2 shows an operation waveform of the output stage 11 arranged as above.

The output stage 11 supplies a common electrode potential Vcom to the COM output terminal 102 in accordance with inputted common polarity inversion signal and control signal s1. The common polarity inversion signal (not shown) has a High period and a Low period, each of which is equal to 1 horizontal period. During one of the High period and the Low period, the common polarity inversion signal gives an instruction to make the common electrode potential Vcom positive (voltage level V1), and during the other one of the High period and the Low period, the common polarity inversion signal gives an instruction to make the common electrode potential Vcom negative (voltage level V2).

The control signal s1 has a waveform such that the control signal s1 becomes a High level during an initial period (partial period) t1 of each horizontal period in which the common electrode potential Vcom becomes positive, and becomes a Low level during a remaining period (partial period) t2 of the horizontal period, and has a waveform such that the control signal s1 becomes a High level during an initial period (partial period) t3 of each horizontal period in which the common electrode potential. Vcom becomes negative, and becomes a Low level during a remaining period (partial period) t4 of the horizontal period. Here, t1=t3 and t2=t4 are satisfied. The first switch SWa turns ON in a case where the control signal s1 has a Low level, and turns OFF in a case where the control signal s1 has a High level. The second switch SWa turns ON in a case where the control signal s1 has a High level, and turns OFF in a case where the control signal s1 has a Low level.

That is, during the periods t1 and t3, the second switch SWb turns ON and the first switch SWa turns OFF, and during the periods t2 and t4, the first switch SWa turns ON and the second switch SWb turns OFF. Accordingly, during the periods (partial periods including start of a polarity inversion operation) t1 and t3, the common electrode potential Vcom is supplied from the second output stage 11b, and during the periods t2 and t4, the common electrode potential Vcom is supplied from the first output stage 11a.

As described above, in the present configuration, each supply period of a common electrode potential of each polarity is divided into a plurality of partial periods.

The second output stage 11b has a larger output impedance than the first output stage 11a, and therefore has smaller load driving capability than the first output stage 11a. Accordingly, a time constant of a waveform change of the common electrode potential Vcom is larger during the periods t1 and t3 than during the periods t2 and t4. That is, in a case where a common electrode potential Vcom of a positive polarity is supplied, the common electrode potential Vcom rises slowly during the period t1 until a first halfway potential level is reached, and then rises speedily during the period t2 until the voltage level V1, which is a final potential level, is reached. Falling of the common electrode potential Vcom of a positive polarity is identical to rising of a common electrode potential Vcom of a negative polarity. Specifically, the common electrode potential Vcom falls (rises in the case of the common electrode potential Vcom of a negative polarity) slowly during the period t3 until a second halfway potential level is reached, and then falls (rises in the case of the common electrode potential Vcom of a negative polarity) speedily during the period t4 until the voltage level V2, which is a final potential level, is reached. Further, falling of the common electrode potential Vcom of a negative polarity is identical to rising of the common electrode potential Vcom of a positive polarity.

As a result, only an electric current having a reduced peak flows, as a common electrode current Icom, at a start timing of each of the periods t1 through t4 included in a transition period in which a polarity of the common electrode potential Vcom is inverted.

Consequently, it is possible to suppress occurrence of a radiation noise caused by a large charge/discharge current of a common electrode at the time of common inversion, unlike the conventional techniques.

In FIG. 2, during each supply period of a common electrode potential Vcom of each polarity, a waveform of the common electrode potential Vcom rises at a first change rate from when polarity inversion of the common electrode potential Vcom starts till when a halfway potential on an opposite polarity side of a finally attained potential of the common electrode potential Vcom is reached, and the waveform of the common electrode potential Vcom rises at a second change rate larger than the first change rate until the finally attained potential is reached.

A scanning signal Vg which caused the TFT 14 of the picture element PIX to turn ON has a pulse waveform such that the scanning signal Vg has a High level only during the periods t2 and t4. That is, a period in which data is written into the picture element PIX is within the periods t2 and t4.

[Configuration 2]

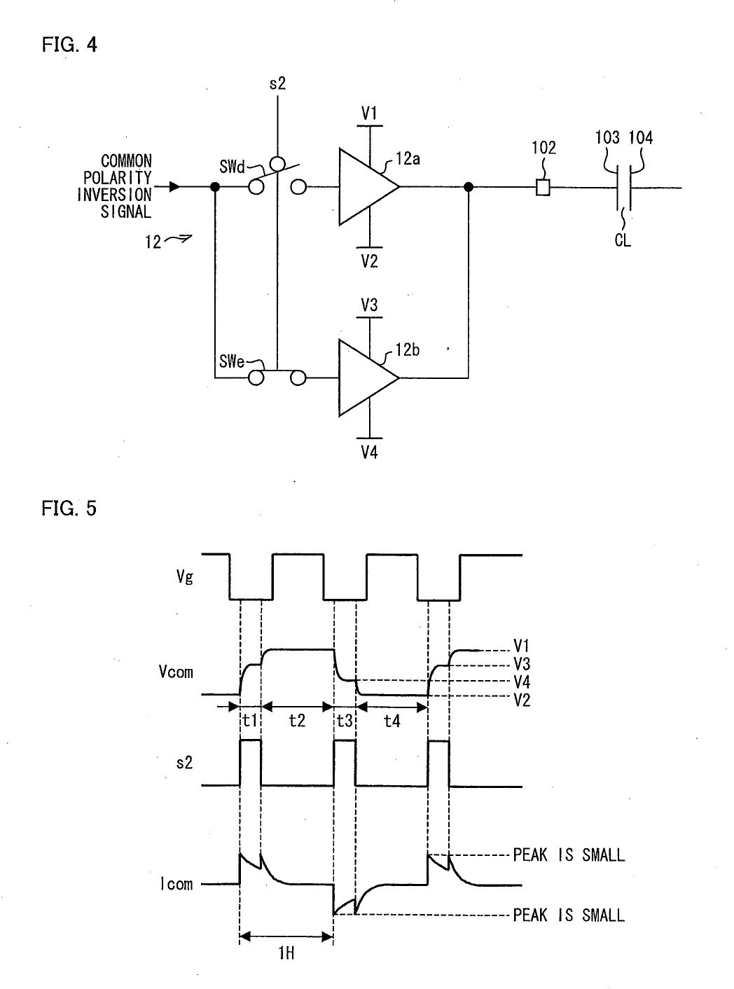

FIG. 4 shows an arrangement of an output stage 12 of a common electrode driving circuit of the present configuration.

The output stage 12 includes a first output stage (sub-output stage, final sub-output stage) 12a, a first switch SWd, a second output stage (sub-output stage, initial sub-output stage) 12b, and a second switch SWe.

Both the first output stage 12a and the second output stage 12b are constituted by output transistors Tp and Tn, as in the case of FIG. 11.

The first output stage 12a outputs a voltage level V1, which is a common electrode potential Vcom of a positive polarity, via the output transistor Tp, and outputs a voltage level V2, which is a common electrode potential Vcom of a negative polarity, via the output transistor Tn. The second output stage 12b outputs a voltage level V3, which is a common electrode potential Vcom of a positive polarity, via the output transistor Tp, and outputs a voltage level V4, which is a common electrode potential Vcom of a negative polarity, via the output transistor Tn. Here, V1>V3>V4>V2 is satisfied. The voltage level V3 is closer to the voltage level V2 an opposite polarity side than the voltage level V1, and the voltage level V4 is closer to the voltage level V1 on an opposite polarity side than the voltage level V2. Accordingly, a change of a potential for charging that is given to the common electrode 103 by the second output stage 12b is smaller than that given by the first output stage 12a. Consequently, the second output stage 12b has smaller load driving capability than the first output stage 12a.

An output of the first output stage 12a and an output of the second output stage 12b are both connected to the COM output terminal 102.

The first switch SWd is connected in series with an input side of the first output stage 12a, and turns ON/Off in accordance with a control signal s2 so that a common polarity inversion signal is allowed/not allowed to be supplied to the first output stage 12a. The second switch SWe is connected in series with an input side of the second output stage 11b, and turns ON/Off in accordance with a control signal s2 so that a common polarity inversion signal is allowed/not allowed to be supplied to the second output stage 12b.

Both (i) a terminal of the first switch SWd which terminal is opposite to a terminal connected to the input side of the first output stage 12a and (ii) a terminal of the second switch SWe which terminal is opposite to a terminal connected to the input side of the second output stage 12b are connected to a supply source of the common polarity inversion signal.

FIG. 5 shows an operation waveform of the output stage 12 arranged as above.

The output stage 12 supplies a common electrode potential Vcom to the COM output terminal 102 in accordance with inputted common polarity inversion signal and control signal s2. The common polarity inversion signal (not shown) has a High period and a Low period, each of which is equal to 1 horizontal period. During one of the High period and the Low period, the common polarity inversion signal gives an instruction to make the common electrode potential Vcom positive (voltage level V1), and during the other one of the High period and the Low period, the common polarity inversion signal gives an instruction to make the common electrode potential Vcom negative (voltage level V2).

The control signal s2 has a waveform such that the control signal s2 becomes a High level during an initial period (partial period) t1 of each horizontal period in which the common electrode potential Vcom becomes positive, and becomes a Low level during a remaining period (partial period) t2 of the horizontal period, and has a waveform such that the control signal s2 becomes an High level during an initial period (partial period) t3 of each horizontal period in which the common electrode potential Vcom becomes negative, and becomes a Low level during a remaining period (partial period) t4 of the horizontal period. Here, t1=t3 and t2=t4 are satisfied. The first switch SWd turns ON in a case where the control signal s2 has a Low level, and turns OFF in a case where the control signal s2 has a High level. The second switch SWe turns ON in a case where the control signal s2 has a High level, and turns OFF in a case where the control signal s2 has a Low level.

That is, during the periods t1 and t3, the second switch SWe turns ON and the first switch SWd turns OFF, and during the periods t2 and t4, the first switch SWd turns ON and the second switch SWe turns OFF. Accordingly, during the periods (partial periods including start of a polarity inversion operation) t1 and t3, the common electrode potential Vcom is supplied from the second output stage 12b, and during the periods t2 and t4, the common electrode potential Vcom is supplied from the first output stage 12a.

As described above, in the present configuration, each supply period of a common electrode potential of each polarity is divided into a plurality of partial periods. The second output stage 12b has a smaller power supply voltage than the first output stage 12a, and therefore has smaller load driving capability than the first output stage 12a. Accordingly, a time constant of a waveform change of a common electrode potential Vcom during the periods t1 and t3 is equal to that during the periods t2 and t4, but a finally attainable voltage is smaller during the periods t1 and t3 than during the periods t2 and t4. That is, In a case where a common electrode potential Vcom of a positive polarity is supplied, the common electrode potential Vcom rises by a small amount during the period t1 until the voltage level V3 is reached, and then reaches the voltage level V1, which is a final potential level, during the period t2. Falling of the common electrode potential Vcom of a positive polarity is identical to rising of a common electrode potential Vcom of a negative polarity. Specifically, the common electrode potential Vcom falls (rises in the case of the common electrode potential Vcom of a negative polarity) by a small amount during the period t3 until the voltage level V4 is reached, and the reaches the voltage level V2, which is a final potential level, during the period t4. Further, falling of the common electrode potential Vcom of a negative polarity is identical to rising of the common electrode potential Vcom of a positive polarity.

As a result, only an electric current having a reduced peak flows, as a common electrode current Icom, at a start timing of each of the periods t1 through t4 included in a transition period in which a polarity of the common electrode potential Vcom is inverted.

Consequently, it is possible to suppress occurrence of a radiation noise caused by a large charge/discharge current of a common electrode at the time of common inversion, unlike the conventional techniques.

In FIG. 5, during each supply period of a common electrode potential Vcom of each polarity, a waveform of the common electrode potential Vcom rises at a first change rate from when polarity inversion of the common electrode potential Vcom starts till when a halfway potential on an opposite polarity side of a finally attained potential of the common electrode potential Vcom is reached, and the waveform of the common electrode potential Vcom rises at a second change rate larger than the first change rate until the finally attained potential is reached.

A scanning signal Vg which caused the TFT 14 of the picture element PIX to turn ON has a pulse waveform such that the scanning signal Vg has a High level only during the periods t2 and t4. That is, a period in which data is written into the picture element PIX is within the periods t2 and t4.

[Configuration 3]

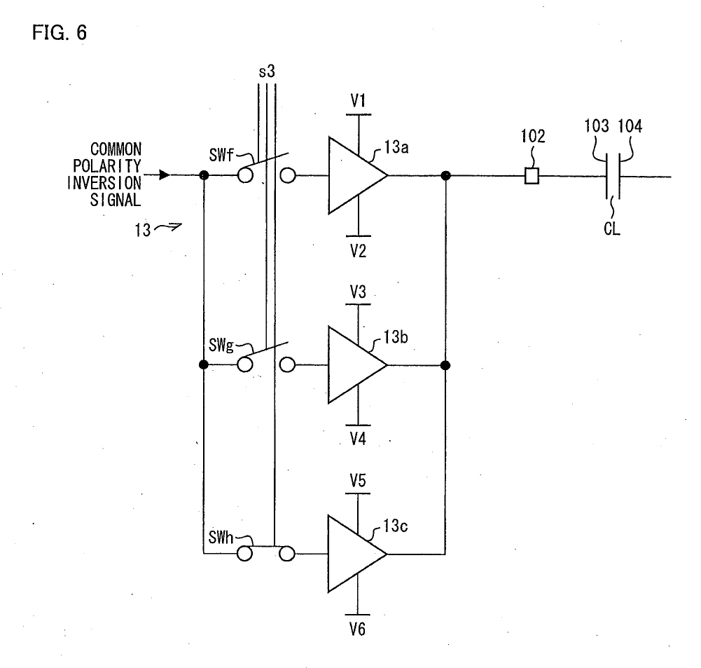

FIG. 6 shows an arrangement of an output stage 13 of a common electrode driving circuit of the present configuration.

The output stage 13 includes a first output stage (sub-output stage, final sub-output stage) 13a, a first switch SWf, a second output stage (sub-output stage) 13b, a second switch SWg, a third output stage (sub-output stage, initial sub-output stage) 13c, and a third switch SWh.

The first output stage 13a, the second output stage 13b, and the third output stage 13c are all constituted by output transistors Tp and Tn, as in the case of FIG. 11.

The first output stage 13a outputs a voltage level V1, which is a common electrode potential Vcom of a positive polarity, via the output transistor Tp, and outputs a voltage level V2, which is a common electrode potential Vcom of a negative polarity, via the output transistor Tn. The second output stage 13b outputs a voltage level V3, which is a common electrode potential Vcom of a positive polarity, via the output transistor Tp, and outputs a voltage level V4, which is a common electrode potential Vcom of a negative polarity, via the output transistor Tn. The third output stage 13c outputs a voltage level V5, which is a common electrode potential Vcom of a positive polarity, via the output transistor Tp, and outputs a voltage level V6, which is a common electrode potential Vcom of a negative polarity, via the output transistor Tn.

An output of the first output stage 13a, an output of the second output stage 13b, and an output of the third output stage 13c are all connected to the COM output terminal 102.

The first switch SWf is connected in series with an input side of the first output stage 13a, and turns ON/OFF in accordance with a control signal s3 so that a common polarity inversion signal is allowed/not allowed to be supplied to the first output stage 13a. The second switch SWg is connected in series with an input side of the second output stage 13b, and turns ON/OFF in accordance with a control signal s3 so that a common polarity inversion signal is allowed/not allowed to be supplied to the second output stage 13b. The third switch SWh is connected in series with an input side of the third output stage 13c, and turns ON/OFF in accordance with a control signal s3 so that a common polarity inversion signal is allowed/not allowed to be supplied to the third output stage 13c.

(1) First, it is assumed that V1=V3=V5>V2=V4=V6 is satisfied.

The output transistor Tp of the second output stage 13b has a larger ON resistance than the output transistor Tp of the first output stage 13a, and the output transistor Tn of the second output stage 13b has a larger ON resistance than the output transistor Tn of the first output stage 13a. The output transistor Tp of the third output stage 13c has a larger ON resistance than the output transistor Tp of the second output stage 13b, and the output transistor Tn of the third output stage 13c has a larger ON resistance than the output transistor Tn of the second output stage 13b. The ON resistance can be increased, for example, by reducing a channel width W of a transistor or by increasing a channel length L. Accordingly, an output impedance of the second output stage 13b is larger than that of the first output stage 13a, and an output impedance of the third output stage 13c is larger than that of the second output stage 13b. That is, the second output stage 13b has smaller load driving capability than the first output stage 13a, and the third output stage 13c has smaller load driving capability than the second output stage 13b.

In this case, in a case where the third switch SWh, the second switch SWg, and the first switch SWf are selectively turned ON in this order in each horizontal period, a common electrode potential Vcom is supplied in the order of the third output stage 13c, the second output stage 13b, and the first output stage 13a, i.e., in ascending order of load driving capability. Accordingly, only an electric current having a reduced peak flows as a common electrode current Icom.

Consequently, it is possible to suppress occurrence of a radiation noise caused by a large charge/discharge current of a common electrode at the time of common inversion, unlike the conventional techniques.

The output stage 13 is not limited to the one described above, and generally may include first through n-th output stages (n is an integer of 2 or larger). Further, a plurality of output stages out of the first through n-th output stages may have the same output impedance, i.e., the same load driving capability. Further, a plurality of output stages out of the first through n-th output stages may supply a common electrode potential Vcom at the same time. Generally, out of the first through n-th output stages, a polarity inversion operation of the common electrode potential is started by one or more output stages whose overall load driving capability (sum of load driving capabilities of the one or more output stages) is smaller than overall load driving capability of one or more output stages which supply a finally attained potential for the common electrode potential Vcom of each polarity. A relationship of largeness of load driving capability between a partial period including a start of the polarity inversion operation and a partial period in which the finally attained potential is supplied is not defined in particular. A sum of load driving capabilities of the output stages can be expressed as a sum of electric currents which the output stages can output under the same load.

(2) Next, it is assumed that V1>V3>V5>V6>V4>V2 is satisfied.

In this case, the second output stage 13b has smaller load driving capability than the first output stage 13a, and the third output stage 13c has smaller load driving capability than the second output stage 13b due to magnitude of a power supply voltage of a common electrode potential Vcom.

In this case, in a case where the third switch SWh, the second switch SWg, and the first switch SWf are selectively turned ON in this order in each horizontal period, a common electrode potential Vcom is supplied in the order of the third output stage 13c, the second output stage 13b, and the first output stage 13a, i.e., in ascending order of load driving capability. Accordingly, only an electric current having a reduced peak flows as a common electrode current Icom.

Consequently, it is possible to suppress occurrence of a radiation noise caused by a large charge/discharge current of a common electrode at the time of common inversion, unlike the conventional techniques.

The output stage 13 is not limited to the one described above, and generally may include first through n-th output stages (n is an integer of 2 or larger). Further, a plurality of output stages out of the first through n-th output stages may have the same power supply voltage of a common electrode potential, i.e., the same load driving capability. Further, out of the first through n-th output stages, the plurality of output stages having the same power supply voltage may supply a common electrode potential Vcom at the same time. Generally, out of the first through n-th output stages, a polarity inversion operation of the common electrode potential is started by one or more output stages whose overall load driving capability (sum of load driving capabilities of the one or more output stages) is smaller than overall load driving capability of one or more output stages which supply a finally attained potential for the common electrode potential Vcom of each polarity. A relationship of largeness of load driving capability between a partial period including a start of the polarity inversion operation and a partial period in which the final electric potential is supplied is not defined in particular. A sum of load driving capabilities of the output stages can be expressed as a sum of electric currents which the output stages can output under the same load.

Note that (1) and (2) can be combined.

[Configuration 4]

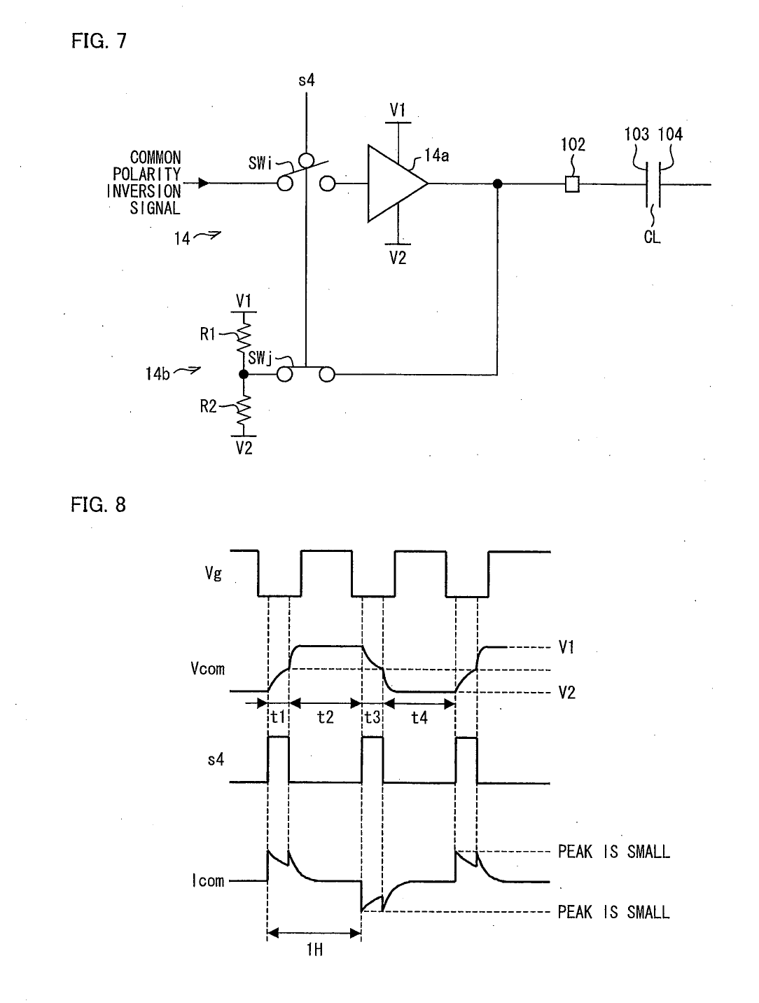

FIG. 7 shows an arrangement of an output stage 14 of a common electrode driving circuit of the present configuration.

The output stage 14 includes a first output stage (sub-output stage, final sub-output stage) 14a, a first switch SWi, a second output stage (sub-output stage, initial sub-output stage) 14b, and a second switch SWj. The second output stage 14b includes a voltage divider including a resistor R1 and a resistor R2 connected in series so that a voltage level difference between a voltage level V1 and a voltage level V2 is divided (V2<V1). The voltage level V1 is applied to one end of the resistor R1, and the voltage level V2 is applied to one end of the resistor R2.

The first output stage 14a is constituted by output transistors Tp and Tn, as in the case of FIG. 11.

An ON resistance of the output transistor Tp of the first output stage 14a is smaller than a resistance value of the resistor R1 of the second output stage 14b, and an ON resistance of the output transistor Tn of the first output stage 14a is smaller than a resistance value of the resistor R2 of the second output stage 14b. The ON resistance can be achieved, for example, by adjusting a channel width W and a channel length L of a transistor. Accordingly, an output impedance of the second output stage 14b is larger than that of the first output stage 14a. That is, the second output stage 14b has smaller load driving capability than the first output stage 14a.

An output of the first output stage 14a is connected to a COM output terminal 102. The first output stage 14a outputs a voltage level V1, which is a common electrode potential Vcom of a positive polarity, via the output transistor Tp, and outputs a voltage level V2 (V2<V1), which is a common electrode potential Vcom of a negative polarity, via the output transistor Tn

The first switch SWi is connected in series with an input side of the first output stage 14a, and turns ON/OFF in accordance with a control signal s4 so that a common polarity inversion signal is allowed/not allowed to be supplied to the first output stage 14a. The second switch SWj is connected to an output side (connection point between the resistor R1 and the resistor R2) of the second output stage 14b, and turns ON/OFF in accordance with a control signal s4 so that a common polarity inversion signal is allowed/not allowed to be supplied to the second output stage 14b.

A terminal of the first switch SWi which terminal is opposite to a terminal connected to the input side of the first output stage 14a is connected to a supply source of the common polarity inversion signal.

FIG. 8 shows an operation waveform of the output stage 14 arranged as above.

The output stage 14 supplies a common electrode potential Vcom to the COM output terminal 102 in accordance with inputted common polarity inversion signal and control signal s4. The common polarity inversion signal (not shown) has a High period and a Low period, each of which is equal to 1 horizontal period. During one of the High period and the Low period, the common polarity inversion signal gives an instruction to make the common electrode potential Vcom positive (voltage level V1), and during the other one of the High period and the Low period, the common polarity inversion signal gives an instruction to make the common electrode potential Vcom negative (voltage level V2).

The control signal s4 has a waveform such that the control signal s4 becomes a High level during an initial period (partial period) t1 of each horizontal period in which the common electrode potential Vcom becomes positive, and becomes a Low level during a remaining period (partial period) t2 of the horizontal period, and has a waveform such that the control signal s4 becomes a High level during an initial period (partial period) t3 of each horizontal period in which the common electrode potential Vcom becomes negative, and becomes a Low level during a remaining period (partial period) t4 of the horizontal period. Here, t1=t3 and t2=t4 are satisfied. The first switch SWa turns ON in a case where the control signal s1 has a Low level, and turns OFF in a case where the control signal s1 has a High level. The second switch SWa turns ON in a case where the control signal s1 has a High level, and turns OFF in a case where the control signal s1 has a Low level.

That is, during the periods t1 and t3, the second switch SWj turns ON and the first switch SWi turns OFF, and during the periods t2 and t4, the first switch SWi turns ON and the second switch SWj turns OFF. Accordingly, during the periods t1 and t3, the common electrode potential Vcom is supplied from the second output stage 14b, and during the periods t2 and t4, the common electrode potential Vcom is supplied from the first output stage 14a.

As described above, in the present configuration, each supply period of a common electrode potential of each polarity is divided into a plurality of partial periods.

The second output stage 14b has a larger output impedance than the first output stage 11a, and therefore has smaller load driving capability than the first output stage 14a. Accordingly, a time constant of a waveform change of the common electrode potential Vcom is larger during the periods t1 and t3 than during the periods t2 and t4. That is, in a case where a common electrode potential Vcom of a positive polarity is supplied, the common electrode potential Vcom rises slowly during the period t1 until a first halfway potential level (not more than (V1−V2)×R2/(R1+R2)) is reached, and then rises speedily during the period t2 until the voltage level V1, which is a final potential level, is reached. Falling of the common electrode potential Vcom of a positive polarity is identical to rising of a common electrode potential Vcom of a negative polarity. Specifically, the common electrode potential Vcom falls (rises in the case of the common electrode potential Vcom of a negative polarity) slowly during the period t3 until a second halfway potential level (not more than (V1−V2)×R2/(R1+R2)) is reached, and then falls (rises in the case of the common electrode potential Vcom of a negative polarity) speedily during the period t4 until the voltage level V2, which is a final potential level, is reached. Further, falling of the common electrode potential Vcom of a negative polarity is identical to rising of the common electrode potential Vcom of a positive polarity.

As a result, only an electric current having a reduced peak flows, as a common electrode current Icom, at a start timing of each of the periods t1 through t4 included in a transition period in which a polarity of the common electrode potential Vcom is inverted.

Consequently, it is possible to suppress occurrence of a radiation noise caused by a large charge/discharge current of a common electrode at the time of common inversion, unlike the conventional techniques.

In FIG. 8, during each supply period of a common electrode potential Vcom of each polarity, a waveform of the common electrode potential Vcom rises at a first change rate from when polarity inversion of the common electrode potential Vcom starts till when a halfway potential on an opposite polarity side to a polarity of the finally attained potential is reached, and then rises at a second change rate larger than the first change rate until the finally attained potential is reached.

A scanning signal Vg which caused the TFT 14 of the picture element PIX to turn ON has a pulse waveform such that the scanning signal Vg has a High level only during the periods t2 and t4. That is, a period in which data is written into the picture element PIX is within the periods t2 and t4.

In order to attain the above object, a display device of the present invention which carries out common inversion driving, includes a common electrode driving circuit including an output stage, the output stage including a plurality of sub-output stages each of which is capable of supplying a voltage to a common electrode, each supply period of a common electrode potential of each polarity being divided into a plurality of partial periods, and a voltage being supplied to the common electrode during each of the plurality of partial periods by one or more sub-output stages selected for said each of the plurality of partial periods, overall load driving capability of an initial sub-output stage constituted by one or more sub-output stages selected during a partial period including start of an operation of polarity inversion of the common electrode potential being smaller than overall load driving capability of a final sub-output stage constituted by one or more sub-output stages selected during a partial period in which a finally attained potential of the common electrode potential of each polarity is supplied.

According to the invention, only an electric current having a reduced peak flows, as an electric current flowing through a common electrode, at a start timing of each of the partial periods which include a partial period in which a voltage is outputted by the initial sub-output stage and which are included in a transition period in which a polarity of the common electrode potential is inverted.

Consequently, it is possible to suppress occurrence of a radiation noise caused by a large charge/discharge current of a common electrode at the time of common inversion, unlike the conventional techniques.

This produces an effect that it is possible to provide a display device that is capable of effectively suppressing a radiation noise which occurs at the time of inversion of a common electrode potential.

In order to attain the above object, the display device of the present invention is arranged such that an overall output impedance of the initial sub-output stage is larger than an overall output impedance of the final sub-output stage.

The invention produces an effect that overall ,load driving capability of the initial sub-output stage and overall load driving capability of the final sub-output stage can be easily set.

In order to attain the above object, the display device of the present invention both the initial sub-output stage and the final sub-output stage include a sub-output stage which outputs a voltage by a push-pull operation using a transistor.

The invention produces an effect that an output impedance can be set based on an ON resistance of a transistor.

In order to attain the above object, the display device of the present invention is arranged such that during each supply period of the common electrode potential of each polarity, a power supply voltage for a voltage outputted from the initial sub-output stage is present on an opposite polarity side to a polarity of the finally attained potential.

The invention produces an effect that overall load driving capability of the initial sub-output stage and overall load driving capability of the final sub-output stage can be easily set.

In order to attain the above object, the display device of the present invention is arranged such that the initial sub-output stage includes a sub-output stage which outputs a voltage divided by a resistor, and the final sub- output stage includes a sub-output stage which outputs a voltage by a push-pull operation using a transistor.

The invention produces an effect that a sub-output stage having a simple arrangement using a resistor can be used.

In order to attain the above object, a method of the present invention for driving a display device which carries out common inversion driving, the display device including a plurality of sub-output stages each of which is capable of outputting a voltage to a common electrode, includes the steps of: dividing each supply period of a common electrode potential of each polarity into a plurality of partial periods; and causing one or more sub-output stages included in an output stage of a common electrode driving circuit to supply a voltage to the common electrode during each of the plurality of partial periods, said one or more sub-output stages being selected for said each of the plurality of partial periods, overall load driving capability of an initial sub-output stage constituted by one or more sub-output stages selected during a partial period including start of an operation of polarity inversion of the common electrode potential being smaller than overall load driving capability of a final sub-output stage constituted by one or more sub-output stages selected during a partial period in which a finally attained potential of the common electrode potential of each polarity is supplied.

According to the invention, only an electric current having a reduced peak flows, as an electric current flowing through a common electrode, at a start timing of each of the partial periods which include a partial period in which a voltage is outputted by the initial sub-output stage and which are included in a transition period in which a polarity of the common electrode potential is inverted.

Consequently, it is possible to suppress occurrence of a radiation noise caused by a large charge/discharge current of a common electrode at the time of common inversion, unlike the conventional techniques.

This produces an effect that it is possible to provide a method for driving a display device that is capable of effectively suppressing a radiation noise which occurs at the time of inversion of a common electrode potential.

In order to attain the above object, the method of the present invention is arranged such that an overall output impedance of the initial sub-output stage is larger than an overall output impedance of the final sub-output stage.

The invention produces an effect -that overall load driving capability of the initial sub-output stage and overall load driving capability of the final sub-output stage can be easily set.

In order to attain the above object, the method of the present invention is arranged such that both the initial sub-output stage and the final sub-output stage include a sub-output stage which outputs a voltage by a push-pull operation using a transistor.

The invention produces an effect that an output impedance can be set based on an ON resistance of a transistor.

In order to attain the above object, the method of the present invention is arranged such that during each supply period of the common electrode potential of each polarity, a power supply voltage for a voltage outputted from the initial sub-output stage is present on an opposite polarity side to a polarity of the finally attained potential.

The invention ,produces an effect that overall load driving capability of the initial sub-output stage and overall load driving capability of the final sub-output stage can be easily set.

In order to attain the above object, the method of the present invention is arranged such that the initial sub-output stage includes a sub-output stage which outputs a voltage divided by a resistor, and the final sub-output stage includes a sub-output stage which outputs a voltage by a push-pull operation using a transistor.

The invention produces an effect that a sub-output stage having a simple arrangement using a resistor can be used.

In order to attain the above object, a display device of the present invention is arranged such that during each supply period of a common electrode potential of each polarity, a waveform of the common electrode potential rises at a first change rate from when polarity inversion of the common electrode potential starts till when a halfway potential on an opposite polarity side to a polarity of a finally attained potential is reached, and the waveform of the common electrode potential rises at a second change rate larger than the first change rate until the finally attained potential is reached.

According to the invention, only an electric current having a reduced peak flows, as an electric current flowing through a common electrode, during a transition period in which a polarity of a common electrode potential is inverted.

Consequently, it is possible to suppress occurrence of a radiation noise caused by a large charge/discharge current of a common electrode at the time of common inversion, unlike the conventional techniques.

This produces an effect that it is possible to provide a display device that is capable of effectively suppressing a radiation noise which occurs at the time of inversion of a common electrode potential.

In order to attain the above object, a method of the present invention is arranged such that during each supply period of a common electrode potential of each polarity, a waveform of the common electrode potential rises at a first change rate from when polarity inversion of the common electrode potential starts till when a halfway potential on an opposite polarity side to a polarity of a finally attained potential is reached, and the waveform of the common electrode potential rises at a second change rate larger than the first change rate until the finally attained potential is reached.

According to the invention, only an electric current having a reduced peak flows, as an electric current flowing through a common electrode, during a transition period in which a polarity of a common electrode potential is inverted.

Consequently, it is possible to suppress occurrence of a radiation noise caused by a large charge/discharge current of a common electrode at the time of common inversion, unlike the conventional techniques.

This produces an effect that it is possible to provide a method for driving a display device that is capable of effectively suppressing a radiation noise which occurs at the time of inversion of a common electrode potential.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention can be suitably applied to various kinds of display devices including a liquid crystal display device.

### REFERENCE SIGNS LIST

1: Liquid crystal display device (display device)

2: Display section

11-14: Output stage

11a,12a,13a,14a: First output stage sub-output stage, final sub-output stage)

11b,12b,14b: Second output stage (sub-output stage, initial sub-output stage)

13b: Second output stage (sub-output stage)

13c: Third output stage (sub-output stage, initial sub-output stage)

103: Common electrode

t1-t4: Period (partial period)

Vcom: Common electrode potential

1. A display device which carries out common inversion driving, comprising:
a common electrode driving circuit including an output stage,
the output stage including a plurality of sub-output stages each of which is capable of supplying a voltage to a common electrode,
each supply period of a common electrode potential of each polarity being divided into a plurality of partial periods, and a voltage being supplied to the common electrode during each of the plurality of partial periods by one or more sub-output stages selected for said each of the plurality of partial periods,
overall load driving capability of an initial sub-output stage constituted by one or more sub-output stages selected during a partial period including start of an operation of polarity inversion of the common electrode potential being smaller than overall load driving capability of a final sub-output stage constituted by one or more sub-output stages selected during a partial period in which a finally attained potential of the common electrode potential of each polarity is supplied.

2. The display device according to claim 1, wherein:
an overall output impedance of the initial sub-output stage is larger than an overall output impedance of the final sub-output stage.

3. The display device according to claim 2, wherein:
both the initial sub-output stage and the final sub-output stage include a sub-output stage which outputs a voltage by a push-pull operation using a transistor.

4. The display device according to claim 1, wherein:
during each supply period of the common electrode potential of each polarity, a power supply voltage for a voltage outputted from the initial sub-output stage is present on an opposite polarity side to a polarity of the finally attained potential.

5. The display device according to claim 2, wherein:
the initial sub-output stage includes a sub-output stage which outputs a voltage divided by a resistor, and
the final sub-output stage includes a sub-output stage which outputs a voltage by a push-pull operation using a transistor.

6. A method for driving a display device which carries out common inversion driving, the display device including a plurality of sub-output stages each of which is capable of outputting a voltage to a common electrode,
the method comprising the steps of:
dividing each supply period of a common electrode potential of each polarity into a plurality of partial periods; and
causing one or more sub-output stages included in an output stage of a common electrode driving circuit to supply a voltage to the common electrode during each of the plurality of partial periods, said one or more sub-output stages being selected for said each of the plurality of partial periods,
overall load driving capability of an initial sub-output stage constituted by one or more sub-output stages selected during a partial period including start of an operation of polarity inversion of the common electrode potential being smaller than overall load driving capability of a final sub-output stage constituted by one or more sub-output stages selected during a partial period in which a finally attained potential of the common electrode potential of each polarity is supplied.

7. The method according to claim 6, wherein:
an overall output impedance of the initial sub-output stage is larger than an overall output impedance of the final sub-output stage.

8. The method according to claim 7, wherein:
both the initial sub-output stage and the final sub-output stage include a sub-output stage which outputs a voltage by a push-pull operation using a transistor.

9. The method according to claim 6, wherein:
during each supply period of the common electrode potential of each polarity, a power supply voltage for a voltage outputted from the initial sub-output stage is present on an opposite polarity side to a polarity of the finally attained potential.

10. The method according to claim 7, wherein:
the initial sub-output stage includes a sub-output stage which outputs a voltage divided by a resistor, and
the final sub-output stage includes a sub-output stage which outputs a voltage by a push-pull operation using a transistor.

11. A display device which carries out common inversion driving, wherein
during each supply period of a common electrode potential of each polarity, a waveform of the common electrode potential rises at a first change rate from when polarity inversion of the common electrode potential starts till when a halfway potential on an opposite polarity side to a polarity of a finally attained potential is reached, and the waveform of the common electrode potential rises at a second change rate larger than the first change rate until the finally attained potential is reached.

12. A method for driving a display device which carries out common inversion driving, wherein
during each supply period of a common electrode potential of each polarity, a waveform of the common electrode potential rises at a first change rate from when polarity inversion of the common electrode potential starts till when a halfway potential on an opposite polarity side to a polarity of a finally attained potential is reached, and the waveform of the common electrode potential rises at a second change rate larger than the first change rate until the finally attained potential is reached.
